(19) United States
(12) Patent Application Publication
(10) Pub. No.: US 2009/0204242 A1
(43) Pub. Date: Aug. 13, 2009

(54) Installer, Peripheral Device Control Apparatus, and Documentary Information Server

(75) Inventor: Masato Honda, Nisshin-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/366,942

(22) Filed: Feb. 6, 2009

(30) Foreign Application Priority Data
Feb. 8, 2008 (JP) 2008-028982

(51) Int. Cl. G06F 17/00

(52) U.S. Cl. 700/90

(57) ABSTRACT

There is provided a computer-readable medium having an installer stored thereon and readable by a peripheral device control apparatus that controls a peripheral device, the installer, when executed by the peripheral device control apparatus, causes the peripheral device control apparatus to install a program for the peripheral device control apparatus. The installer includes a retrieval unit that retrieves an installed program installed on the peripheral device control apparatus to utilize the peripheral device, an acquisition unit that acquires a documentary information on the peripheral device corresponding to the installed program retrieved by the retrieval unit, and an installation unit that installs the documentary information acquired by the acquisition unit on the peripheral device control apparatus, on which the installed program is installed.

### CROSS-REFERENCE TO RELATED APPLICATIONS

This application claims priority from Japanese Patent Application No. 2008-028982 filed on Feb. 8, 2008, the entire subject matter of which is incorporated herein by reference.

### TECHNICAL FIELD

The invention relates to a peripheral device control apparatus controlling a peripheral device such as a printer or a scanner, a program installer for the peripheral device control apparatus, and a documentary information server. Specifically, the invention relates to a peripheral device control apparatus having documentary information on a peripheral device typified by Frequently Asked Questions (FAQ) information, a program installer for the peripheral device control apparatus, and a documentary information server.

### BACKGROUND

Manufactures such as peripheral device manufacturers prepare answers in advance to frequently asked questions from many people. For example, in personal computers (PCs) on which drivers for peripheral devices are installed, the installed operation systems (OS) and applications are different for each PC. Further, the same application and the like may have different versions. In some cases, when an attempt is made to print a document created by utilizing an application, the document can be printed by an old version of the application, but fails to print by a new version of the application. Some manufactures prepares information for solving such problems as FAQ information on their WEB sites.

A user can find solution for solving the problems by accessing the FAQ information instead of making an inquiry to a help desk or a call center of the manufacturer. Accordingly, an attempt can be made to achieve an early solution to the problems. Further, it may be possible to reduce the load on the help desk and the like.

JP-A-2003-108355 discloses a related technique utilizing such FAQ information. For example, when a problem occurs in a printer, a user can access a WEB server having FAQ information of the printer, and the user can display the FAQ information.

### SUMMARY

Illustrative aspects of the invention provide a peripheral device control apparatus providing documentary information on a peripheral device suitable for a use environment of a user, a program installer for the peripheral device control apparatus, and a documentary information server.

### BRIEF DESCRIPTION OF THE DRAWINGS

Illustrative aspects of the invention will be described in detail with reference to the following figures wherein:

FIG. 1 is a block diagram showing a FAQ providing system according to an exemplary embodiment of the invention;

FIG. 2 is a block diagram showing a PC and a FAQ server of the FAQ providing system;

FIG. 3 is a diagram showing an example of a database recording types and versions of applications installed on the PC;

FIG. 4 is a diagram showing functional configuration of the PC and a CD-ROM according to a first example for providing FAQ information;

FIG. 5 is a diagram showing an example of a database recording combinations of an OS and applications installed on an installer;

FIG. 6 is a diagram showing an example of FAQ information installed on the installer;

FIG. 7 is a flowchart showing operation procedure of the installer according to the first example;

FIG. 8 is a diagram showing functional configuration of the PC and the FAQ server according to a modification to the first example;

FIG. 9 is a diagram showing functional configuration of the PC and the FAQ server according to a second example for providing FAQ information;

FIG. 10 is a flowchart showing operation procedure of the application in the PC according to the second example;

FIG. 11 is a diagram showing an example of a start menu display of the PC;

FIG. 12 is a diagram showing an example of a user interface of a printer driver;

FIG. 13 is a flowchart showing operation procedure of the application in the FAQ server according to the second example;

FIG. 14 is a diagram showing functional configuration of the PC and the FAQ server according to a first modification to the second example; and

FIG. 15 is a flowchart showing operation procedure of a resident application in the PC according to a second modification to the second example.

### DETAILED DESCRIPTION

### <General Overview>

The related art technique as described above has some disadvantages. For example, a solution for problems in a driver of a peripheral device varies according to a state of an OS or an installed application, a version of software, and a version of driver, etc. Therefore, FAQ information is prepared for each driver, each OS, each application, and is further prepared for each version thereof. Under such circumstances, a user is required to grasp the environment of the PC (i.e., the OS, the application, and the state of installing the driver) prior to retrieve the FAQ information. However, it is not convenient for the user. Further, some user may not properly grasp the environment of the PC. In such a case, the user may not reach correct FAQ information. Thus, the user may give up solving the problems and make an inquiry to a support center or the like.

Therefore, illustrative aspects of the invention provide a peripheral device control apparatus providing documentary information on a peripheral device suitable for a use environment of a user, a program installer for the peripheral device control apparatus, and a documentary information server.

According to a first aspect of the invention, there is provided a computer-readable medium having an installer stored thereon and readable by a peripheral device control apparatus that controls a peripheral device, the installer, when executed by the peripheral device control apparatus, causes the peripheral device control apparatus to install a program for the peripheral device control apparatus, the installer comprising: a retrieval unit that retrieves an installed program installed on the peripheral device control apparatus to utilize the peripheral device; an acquisition unit that acquires a documentary information on the peripheral device corresponding to the installed program retrieved by the retrieval unit; and an installation unit that installs the documentary information acquired by the acquisition unit on the peripheral device control apparatus, on which the installed program is installed.

The installer stored on the computer-readable medium according to the invention retrieves the program installed on the peripheral device control apparatus. The program is an example of an installed program. The term “program” is a program to utilize a peripheral device (i.e., a printer or a scanner) such as word-processing software or spreadsheet software, for example. Further, an OS and a driver for the peripheral device are included in the program. The installer acquires the documentary information on the peripheral device corresponding to the installed program. The term “documentary information” on the peripheral device means information specific to the peripheral device, that corresponds to FAQ information and version upgrade information, for example. The installer installs the acquired documentary information on the peripheral device control apparatus.

That is, in the installer according to the invention, the documentary information on the peripheral device acquired by the acquisition unit is associated with the program, and documentary information corresponding to the installed program is installed. Therefore, the documentary information associated with the program installed on the peripheral device control apparatus is automatically acquired, whereas the documentary information unrelated to the program installed on the peripheral device control apparatus is not installed. Accordingly, the installed documentary information is only the information suitable for the peripheral device control apparatus targeted for installation. Therefore, a user can obtain correct information regardless of the environment of the peripheral device control apparatus (i.e., the types, the versions, the languages, and the like of the installed applications). Further, since it is not necessary for the user to retrieve documentary information, acquisition of incorrect documentary information can be avoided. Further, with respect to the documentary information to be installed, only some of the information suitable for the peripheral device control apparatus is installed. Therefore, amount of space required to install the documentary information can be reduced compared to a case in which all the documentary information is installed. Accordingly, resources of the peripheral device control apparatus serving as a destination for installation can be effectively used.

According to a second aspect of the invention, in the computer-readable medium, the installer further comprises: a retention unit that retains various types of documentary information on peripheral devices, wherein the acquisition unit extracts the documentary information on the peripheral device corresponding to the installed programs from the retention unit. That is, since the installer itself includes the documentary information on the peripheral device, the documentary information can be installed even if a network environment is not good.

According to a third aspect of the invention, in the computer-readable medium, the peripheral device control apparatus comprises a communication unit that is accessible to a server retaining various types of documentary information on peripheral devices, and when the peripheral device control apparatus transmits data on the installed program to the server by the communication unit, the server extracts the installed program in accordance with the data transmitted by the peripheral device control apparatus, and the acquisition unit acquires the documentary information on the peripheral device corresponding to the installed program extracted by the server. That is, in this installer, the documentary information is acquired from the server. The documentary information is always updated at the side of the server. Therefore, it is possible to always install the latest documentary information.

According to a fourth aspect of the invention, in the computer-readable medium, the documentary information comprises at least one of a documentation, a help information and a FAQ information.

According to a fifth aspect of the invention, there is provided a peripheral device control apparatus comprising: a program storage unit that stores a program to utilize a peripheral device; a documentary information storage unit that stores a documentary information on the peripheral device; an acceptance unit that accepts an update instruction of updating the documentary information stored in the documentary information storage unit; a retrieval unit that retrieves an installed program installed on the program storage unit according to the update instruction accepted by the acceptance unit; an acquisition unit that acquires the documentary information corresponding to installed programs retrieved by the retrieval unit; and an update unit that updates the documentary information stored in the documentary information storage unit to the documentary information acquired by the acquisition unit.

The peripheral device control apparatus according to the invention accepts an update of documentary information to retrieve program installed (installed program) according to an instruction for the update. Then, the peripheral device control apparatus acquires documentary information on the peripheral device corresponding to the installed program. Then, the peripheral device control apparatus updates the documentary information.

That is, in the peripheral device control apparatus according to the invention, the documentary information on the peripheral device acquired by the acquisition unit is associated with the program, and documentary information corresponding to the installed program is acquired. Therefore, the documentary information suitable for the environment of the peripheral device control apparatus is automatically acquired, and the documentary information unrelated to the program installed on the apparatus is not acquired. Accordingly, the updated documentary information is information suitable for the apparatus. Therefore, it is possible for a user to obtain correct information regardless of the environment of the peripheral device control apparatus. Further, because there is no need for the user himself/herself to retrieve documentary information, acquisition of incorrect documentary information can be avoided.

According to a sixth aspect of the invention, the peripheral device control apparatus further comprises: a retention unit that retains various types of documentary information on peripheral devices, wherein the acquisition unit acquires the documentary information on the peripheral device corresponding to the installed programs from the retention unit. That is, the peripheral device control apparatus itself includes the documentary information on the peripheral device. Therefore, it is possible to update the documentary information even if a network environment is not good.

According to a seventh aspect of the invention, the peripheral device control apparatus further comprises: a communication unit that is accessible to a server retaining documentary information on the peripheral device corresponding to various types of programs, wherein, when the peripheral device control apparatus transmits data on the installed program to the server by the communication unit, the server extracts the installed program in accordance with the data transmitted by the peripheral device control apparatus, and the acquisition unit acquires the documentary information on the peripheral device corresponding to the installed programs extracted by the server. That is, in the peripheral device control apparatus, the documentary information is acquired from the server. Therefore, by updating the documentary information at the side of the server, it is possible to acquire the latest documentary information.

According to an eighth aspect of the invention, the peripheral device control apparatus further comprises: an instruction unit that outputs an instruction for update to the acceptance unit at predetermined intervals. That is, the instruction unit periodically outputs an instruction for update. Therefore, it is possible to automatically acquire suitable documentary information for the peripheral device of the current environment. Therefore, the user is not required to update the documentary information. Accordingly, usability can be enhanced.

According to a ninth aspect of the invention, in the peripheral device control apparatus, the documentary information comprises at least one of a documentation, a help information and a FAQ information.

According to a tenth aspect of the invention, there is provided a documentary information server comprising: a database that retains various types of documentary information on peripheral devices; a data acquisition unit that acquires a data on an installed program installed on a peripheral device control apparatus to utilize the peripheral device; an extraction unit that extracts a documentary information on the peripheral device corresponding to the installed programs from the database on the basis of the data acquired by the data acquisition unit; and a transmission unit that transmits the documentary information extracted by the extraction unit to the peripheral device control apparatus.

According to an eleventh aspect of the invention, in the documentary information server, the documentary information comprises at least one of a documentation, a help information and a FAQ information.

According to a twelfth aspect of the invention, there is provided a method for installing a documentary information on a peripheral device control apparatus, the peripheral device control apparatus being coupled to a peripheral device and controlling the peripheral device, the method comprising: detecting an installed program installed on the peripheral device control apparatus; and installing a documentary information on the detected installed program on the peripheral device control apparatus.

According to a thirteenth aspect of the invention, the method for installing a documentary information further comprises: extracting only a documentary information on operation of the peripheral device coupled to the peripheral device controlling apparatus from a documentary information database retaining various types of documentary information on peripheral devices.

According to a fourteenth aspect of the invention, the method for installing a documentary information further comprises: acquiring a documentary information on the detected installed program; wherein the acquiring a documentary information comprises: connecting a server including a documentary information database; sending an information on the detected installed program to the documentary information database; and receiving the documentary information on the detected installed program from the documentary information database.

According to a fifteenth aspect of the invention, the method for installing a documentary information further comprises: acquiring a documentary information on the detected installed program, wherein the acquiring a documentary information comprises reading the documentary information on the detected installed program from a computer-readable medium storing the documentary information database.

According to a sixteenth aspect of the invention, in the method for installing a documentary information, the documentary information comprises at least one of a documentation, a help information and a FAQ information.

### <Exemplary Embodiments>

Exemplary embodiments of the invention will be described with reference to the drawings.

In the exemplary embodiment of the invention, a printer serving as a peripheral device and a PC serving as a control apparatus for the peripheral device are provided. The exemplary embodiment of invention is applied to the PC, an installer to install a printer driver on the PC, and a server connecting to the PC via a network.

### (FAQ Providing System)

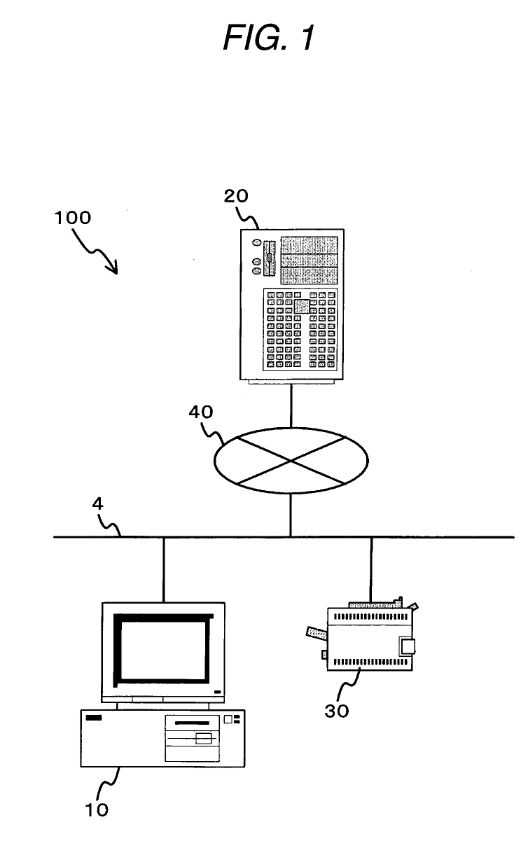

A FAQ providing system 100 includes a PC 10 and a printer 30 as shown in FIG. 1. In the FAQ providing system 100, the PC 10 and the printer 30 are connected via a network 4 such as a LAN. Further, the FAQ providing system 100 includes a FAQ server 20 storing the latest FAQ information. The FAQ server 20 is connected to the PC 10 via an Internet 40. Incidentally, the printer and the PC of the system 100 are not limited to a single unit. A plurality of printers and PCs may be connected to one another.

In the FAQ providing system 100, the PC 10 is capable of utilizing the printer 30 via the network 4. That is, a printer driver for the printer 30 is installed in the PC 10, to be capable of outputting a print instruction to the printer 30.

Further, in the FAQ providing system 100, the PC 10 is capable of accessing the FAQ server 20 via the Internet 40. The PC 10 and the server 20 exchange FAQ information therebetween. The FAQ server 20 in the exemplary embodiment of the invention is set as a WEB server provided by a manufacturer of the printer 30. That is, the FAQ server 20 provides product information and FAQ information on the printer 30.

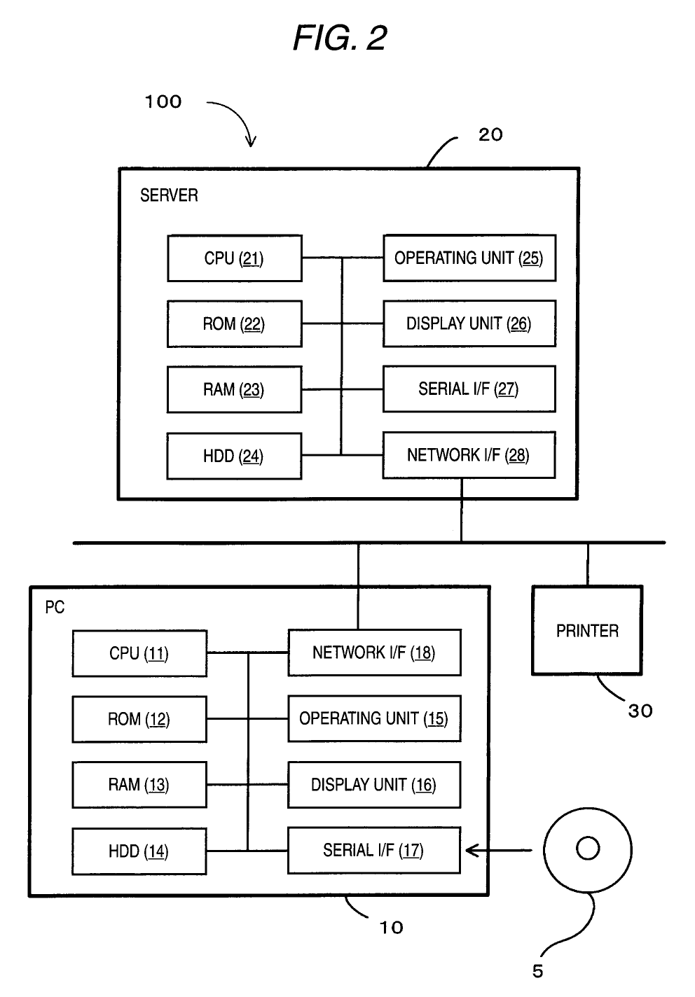

Specifically, as shown in FIG. 2, the PC 10 includes a CPU 11 (one example of an acceptance unit, a retrieval unit, an acquisition unit, an installation unit, an update unit, and an instruction unit), a ROM 12 storing a program for boot processing (BIOS) which the CPU 11 executes at the time of booting the PC 10, a RAM 13 utilized as a temporary storage area when the CPU 11 executes various types of processing, and a hard disk drive (HDD) 14 (one example of a program storage unit and a documentary information storage unit) storing various types of programs and data.

Further, the PC 10 includes an operating unit 15 including a keyboard, a mouse, and the like, a display unit 16 including a liquid crystal display and the like, a serial port interface 17 exchanging signals with another information device such as a CD-ROM driver, and a network interface 18 (one example of a communication unit) exchanging signals via a network such as a LAN or the Internet.

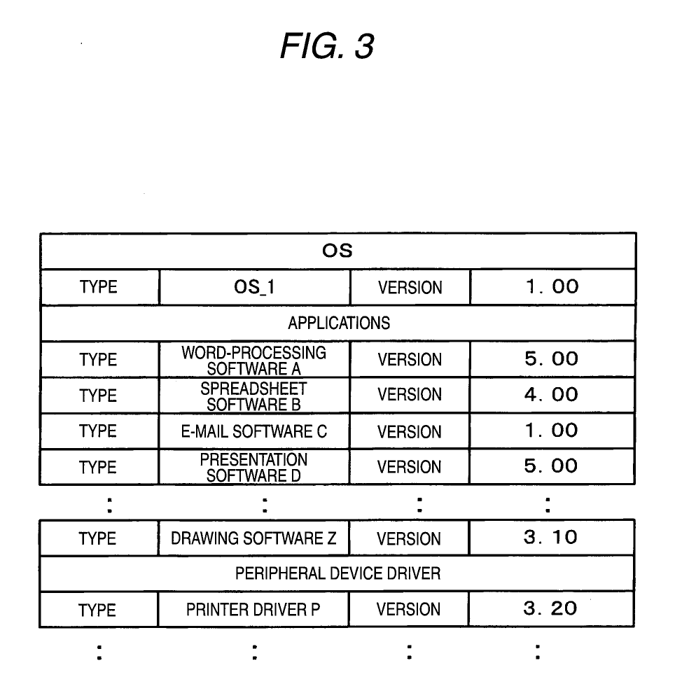

The HDD 14 of the PC 10 stores an OS, a printer driver to control the printer 30, various types of applications such as word-processing and spreadsheet software, or the like. Further, as one of the functions of the OS, an environmental information database recording the types, the versions, and the various types of settings of the applications installed on the PC 10 (installed application: one example of installed programs) is provided. This environmental information database records, for example, the type and the version of the OS, the types of the versions of the applications installed on the PC 10, and the type and the version of the printer driver, as shown in FIG. 3.

The FAQ server 20 (one example of a server retaining documentary information on the peripheral device corresponding to various types of programs) includes a CPU 21 executing various types of arithmetic processing, a ROM 22 storing a program for boot processing (BIOS) which the CPU 21 executes at the time of booting the server 20, a RAM 23 utilized as a temporary storage area when the CPU 21 executes various types of processing, and a hard disk drive (HDD) 24 storing various types of programs and data.

Further, the FAQ server 20 has an operating unit 25 composed of a keyboard, a mouse, and the like, a display unit 26 composed of a liquid crystal display and the like, a serial port interface 27 exchanging signals with another information device such as a CD-ROM driver, and a network interface 28 exchanging signals via a network such as a LAN or the Internet.

Further, a server program to provide content such as FAQ information via the Internet is installed on the HDD 24 of the FAQ server 20. Further, a database storing FAQ information prepared for each application type and each of the versions of the respective applications, is provided. The content such as FAQ information is sequentially updated to be the latest content by a manufacturer.

### (Operation for Providing FAQ Information)

Next, two methods for providing FAQ information will be described. One method is to install FAQ information at the time of installing the printer driver as one of the functions of an installer when a printer driver is installed on the PC 10. This method will be described later as a first example. Another method is to access the FAQ server 20 at the user's desired timing to download the latest FAQ information to update it as one of the functions of the applications installed on the PC 10. This method will be described later as a second example.

### FIRST EXAMPLE

### Installer

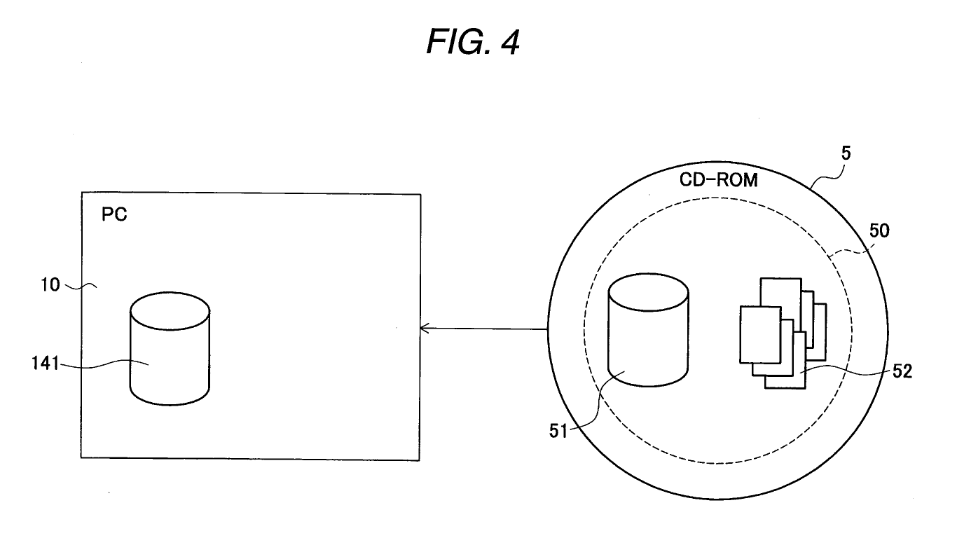

The first example of providing FAQ information will now be described. In the first example, FAQ information is installed along with a printer driver by an installer. The installer in the first example is recorded on a CD-ROM 5 as shown in FIG. 4. The installer 50 installs FAQ information suitable for a PC serving as a destination for installation (which is the PC 10 in the first example) on the HDD 14 via the serial port interface 17.

A database 51 recording the combinations of an OS and applications and a FAQ information group 52 prepared so as to correspond to the combinations are incorporated in the installer 50. The FAQ information to be installed is determined on the basis of an identifier extracted from the FAQ information group 52 on the basis of the database 51.

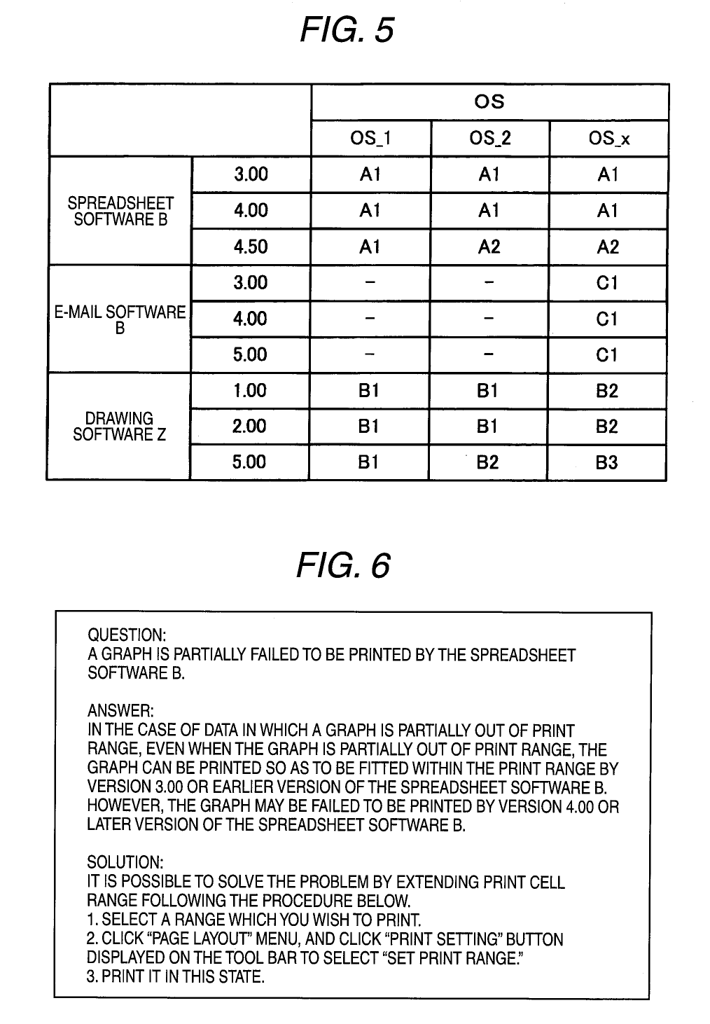

FIG. 5 shows one example of the database 51. Combinations of an OS and applications and identifiers of FAQ information determined on the basis of the combinations are recorded in the database 51. In FIG. 5, “A1” and “A2” correspond to the identifiers. The versions of the respective applications and the OS are taken into account for the combinations of the OS and the applications. For example, when the OS is “OS_{—}1” and the application is version 4.00 of “spreadsheet software B,” “A1” is determined as an identifier for the combination on the basis of the database 51 shown in FIG. 5.

For each identifier, FAQ information corresponding to the identifier is recorded in advance in the installer 50. Those pieces of FAQ information constitute the FAQ information group 52 (one example of a retention unit). That is, as FAQ information corresponding to the identifier “A1,” for example, FAQ information associated with the corresponding application as shown in FIG. 6 is recorded in the installer 50. Such FAQ information is provided to each identifier.

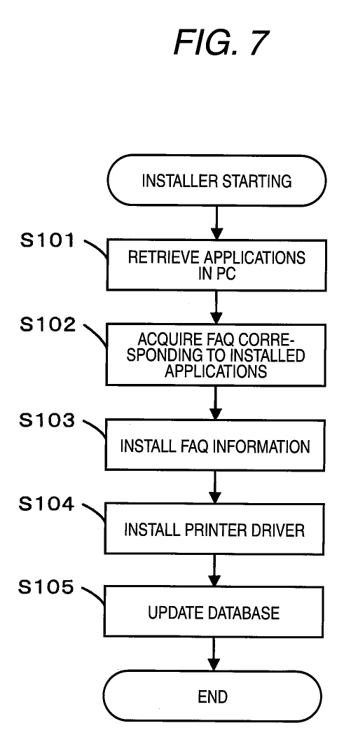

Hereinafter, the operation procedure of the installer 50 in the first example will be described with reference to a flowchart of FIG. 7. The installer 50 is automatically started when the CD-ROM 5 is inserted into the PC 10.

First, the installer 50 retrieves applications installed within the PC 10 (installed applications) (S101: one example of a retrieval unit). The OS is included in the installed applications. The information on the installed applications can be acquired from an environmental information database 141 (refer to FIG. 4) installed in the PC 10. In the retrieval, not only the types of the applications, but also the versions and the languages of the applications are retrieved.

Next, the installer 50 acquires FAQ information corresponding to the installed applications (S102: one example of an acquisition unit). That is, identifiers are extracted on the basis of the database 51 (refer to FIG. 5) incorporated in the installer 50, and FAQ information corresponding to the identifiers is extracted from the FAQ information group 52. Incidentally, FAQ information is not necessarily extracted. FAQ information is not extracted depending on the combination in some cases (for example, combinations corresponding to identifiers “-” in FIG. 5). Further, FAQ information on applications and an OS which are not registered with the database 51 are not extracted.

Next, the installer 50 installs the acquired FAQ information on the PC 10 (S103: one example of an installation unit). In accordance therewith, only the FAQ information suitable for the installed applications is installed on the PC 10. That is, the FAQ information specialized for the environment of the PC 10 targeted for installation is installed. Thereafter, the installer 50 selects a printer driver suitable for the OS on the basis of an OS installed on the PC 10 (S104), to install the FAQ information.

Not only the FAQ information for each of the installed applications, but also common FAQ information for all the applications and FAQ information unrelated to the applications (information associated with problems specific to the printer 30) are included in the FAQ information to be installed. That is, even if FAQ information is not extracted by the processing at S102, at least common FAQ information is acquired by the processing at S103, and the FAQ information is installed.

After the printer driver is installed, the installer 50 updates the environmental information database 141 of the PC 10 (S105). That is, the installer 50 writes the fact that the new printer driver is added into the environmental information database 141 of the PC 10. After the processing at S105, the installer 50 completes the installation processing.

Incidentally, in the first example, the storage medium of the installer 50 is the CD-ROM 5. However, the storage medium is not limited thereto. For example, the storage medium may be a flexible disk or a DVD-ROM.

### MODIFICATION TO FIRST EXAMPLE

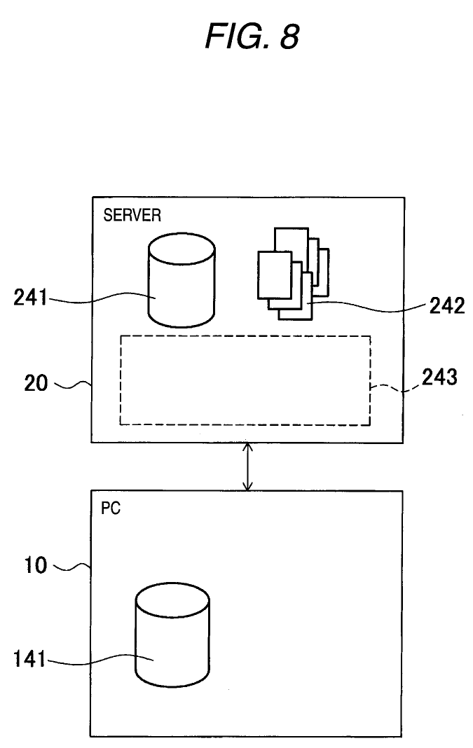

As shown in FIG. 8, an installer 243 may be stored in the FAQ server 20. By using the network interface 18, the network 4 and the Internet 40, the PC 10 may transmit the information on an installed program to the FAQ server 20 at the time of installation, and may download the FAQ information extracted by the FAQ server 20 to install the FAQ information. In this case, a database 241 recording the combinations of an OS and applications and a FAQ information group 242 prepared so as to correspond to the combinations are incorporated in the FAQ server 20. Installing FAQ information by a network environment in this way enables obtaining the latest FAQ information at the point in time of installation. In contrast, when the installer 50 includes the database 51 and the FAQ information group 52 as in the first example, it is possible to update the FAQ information without a network environment.

### SECOND EXAMPLE

### Download FAQ Information

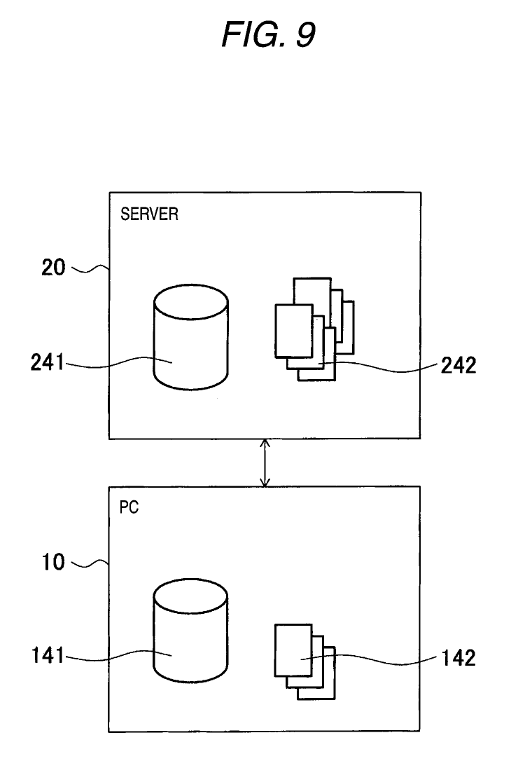

The second example of providing FAQ information will now be described. In the second example, the PC 10 accesses the FAQ server 20 at the user's desired timing to download the latest FAQ information. As for the desired timing, a time after a user newly installs an application, or a time after the user upgrades a driver for a peripheral device are appropriate. That is, in the second example, as shown in FIG. 9, a printer driver is already installed on the PC 10, and the PC 10 has FAQ information 142.

The database 241 recording the combinations of an OS and applications and the FAQ information group 242 prepared so as to correspond to the combinations are incorporated in the FAQ server 20. The content to be recorded in the database 241 is the same as that in the database 51 of the installer 50. The FAQ information group 242 is the same as the FAQ information group 52 of the installer 50. The database 241 and the FAQ information group 242 in the FAQ server 20 may be always updated to be the latest information.

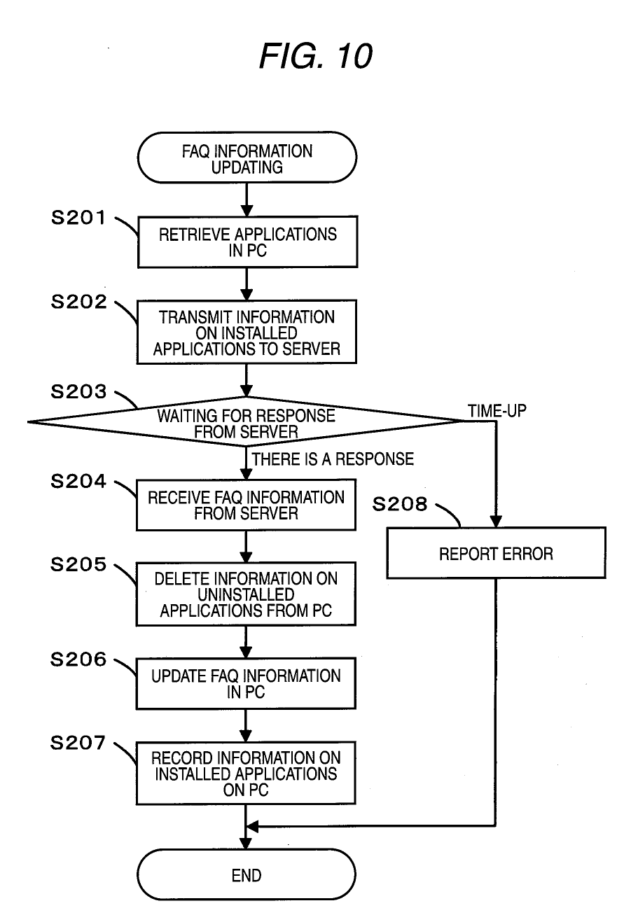

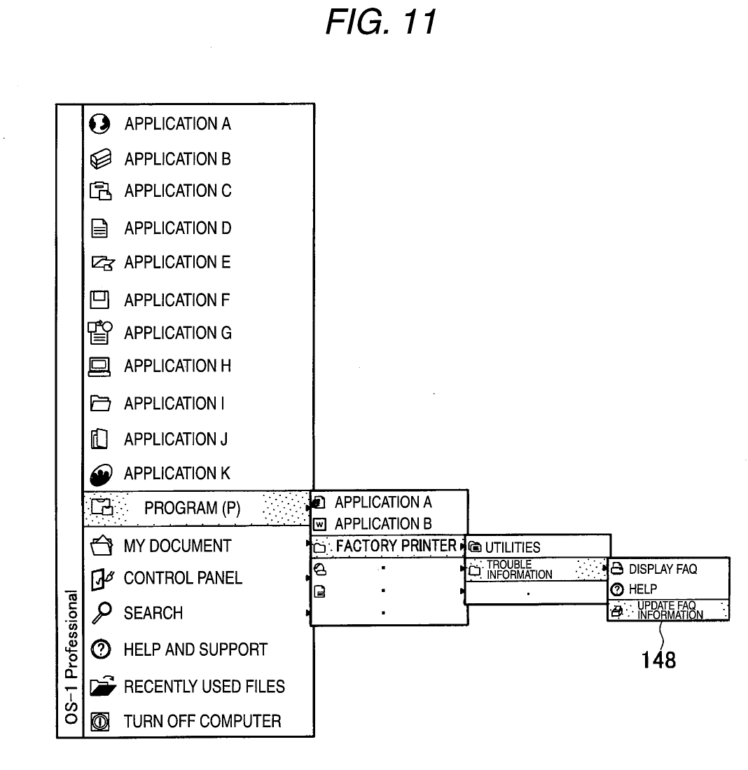

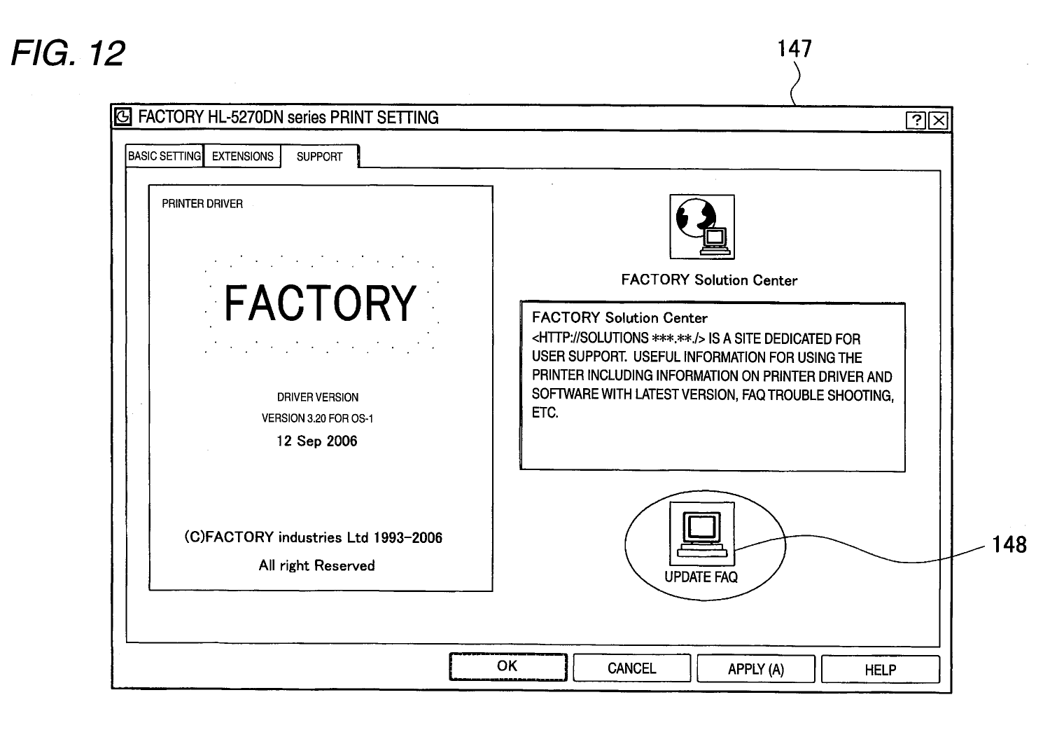

Hereinafter, the operation procedure with respect to processing for updating FAQ information of the PC 10 in the second example will be described with reference to a flowchart of FIG. 10. The processing for updating FAQ information is started from a start menu 146 (one example of an acceptance unit) which is the user interface of the OS as shown in, for example, FIG. 11. Further, the processing for updating FAQ information is started by pressing down a button 148 (one example of an acceptance unit) displayed on a utility 147 of the printer driver as shown in, for example, FIG. 12.

First, the PC 10 retrieves applications installed in the PC 10 (installed applications) (S201: one example of a retrieval unit). The information on the installed applications can be acquired from the environmental information database 141 (refer to FIG. 4) installed in the PC 10 (S203).

Next, the PC 10 transmits the information on the installed applications serving as the result of the processing at S201 to the FAQ server 20 (S202: one example of a communication unit). After the transmission, the PC 10 comes to wait for a response from the FAQ server 20.

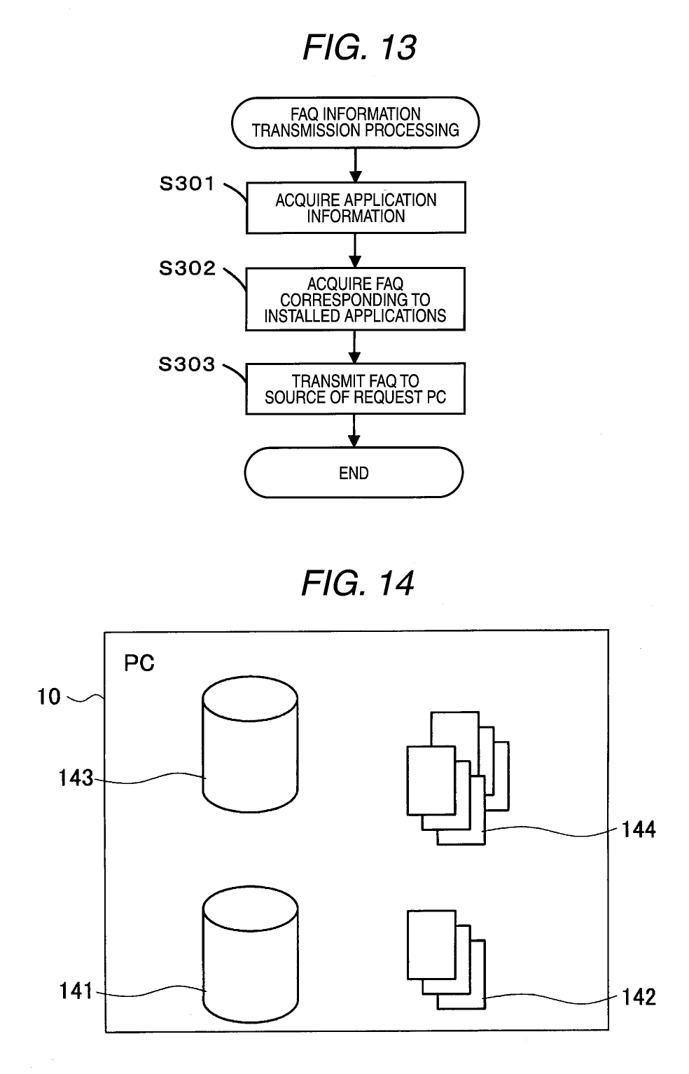

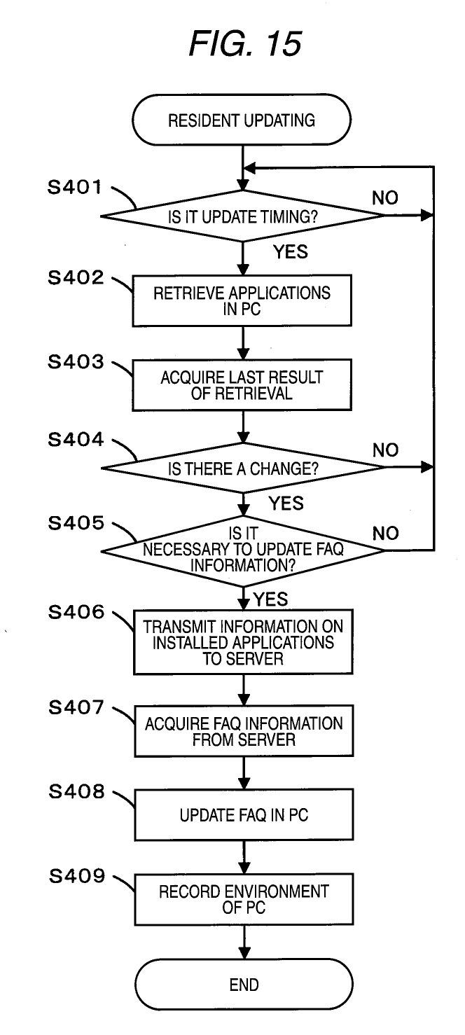

The FAQ server 20 waits for the information on the installed applications to extract FAQ information. The processing for transmitting FAQ information by the FAQ server 20 will be described with reference to a flowchart of FIG. 13.

First, the FAQ server 20 acquires information on the installed applications (S301: one example of a data acquisition unit). In the second example, the FAQ server 20 acquires the information on the installed applications transmitted from the PC 10. Next, the FAQ server 20 acquires FAQ information corresponding to the installed applications (S302: an extraction unit). That is, identifiers are extracted on the basis of the database 241 in the FAQ server 20, and FAQ information corresponding to the identifiers is extracted from the FAQ information group 242.

Next, the FAQ server 20 transmits the acquired FAQ information to the PC which is the source transmitting the information on the installed applications (S303: a transmission unit). That is, the FAQ server 20 transmits the FAQ information to the PC 10. In accordance therewith, only the FAQ information suitable for the installed applications in the PC 10 are transmitted. After the processing at S303, the processing for transmitting FAQ information by the FAQ server 20 is completed.

To return to the processing for updating FAQ information in the PC 10, when there is a response from the FAQ server 20 (S203: YES), the PC 10 acquires the latest FAQ information from the FAQ server 20 (S204: one example of an acquisition unit). In contrast, when there is no response from the FAQ server 20 (S203: NO), an error message is displayed on the display unit 16 of the PC 10 (S208), and the PC 10 completes the processing for updating FAQ information.

After the PC 10 acquires the FAQ information by the processing at S204, the PC 10 compares the environment at the time of acquiring the FAQ information before update and the environment at the time of acquiring the FAQ information after update (i.e., under the present state), to extract information on deleted applications. Then, the PC 10 deletes the FAQ information on the deleted applications (S205).

Thereafter, the PC 10 updates the FAQ information 142 in the PC (S206: one example of an update unit). In accordance therewith, FAQ information corresponding to the newly installed application is installed on the PC 10. That is, the FAQ information is updated to be FAQ information specialized for the environment of the PC 10 under the present state. After the update, the environment of the PC 10 under the present state is recorded (S207), which completes this processing.

### FIRST MODIFICATION TO SECOND EXAMPLE

In the second example, the FAQ information suitable for the environment of the PC 10 under the present state is acquired from the FAQ server 20. Alternatively, as shown in FIG. 14, the PC 10 may have a database 143 recording the combinations of an OS and applications and a FAQ information group 144 (one example of a retention unit) prepared so as to correspond to the combinations. That is, the PC 10 updates the FAQ information 142 on the basis of the database 143 and the FAQ information group 144. In accordance therewith, it is possible for a user to obtain suitable FAQ information by accessing the FAQ information 142. Accordingly, since the PC 10 includes the database 143 and the FAQ information group 144, it is possible to update the FAQ information without a network environment. In contrast, updating FAQ information by a network environment as in the second example enables obtaining the latest FAQ information. Further, since there is no need to keep the database 143 and the FAQ information group 144, the resources of the HDD 14 of the PC 10 can be effectively used.

### SECOND MODIFICATION TO SECOND EXAMPLE

In the second example, the FAQ information is updated in any timing by a user. Alternatively, a resident application installed on the PC 10 may periodically access the FAQ server 20 to download the latest FAQ information and automatically update the FAQ information. A time after twenty-four hours from the last update timing is set as update timing in this second modification to the second example.

In the second modification, first, the resident application determines whether or not it is the update timing for FAQ information (S401: one example of an instruction unit). When it is not the update timing (S401: NO), the resident application stands by for updating until the update timing. When it is the update timing (S401: YES), the resident application retrieves applications installed on the PC 10 (installed applications) (S402).

Next, the resident application acquires environmental information on the PC 10 when the FAQ information is updated the last time (i.e., the result of retrieving the installed applications) (S403). Then, the resident application compares the last result of retrieval and the present result of retrieval, to determine whether or not there is a change therein. When there is no change (S404: NO), the resident application returns to the processing at S401, and the resident application stands by for updating until the next update timing.

When there is a change (S404: YES), the resident application determines whether or not it is necessary to update the FAQ information (S405). That is, applications unrelated to the FAQ information as well exist. In a case of a change in such applications, there is no need to update the FAQ information (S405: NO), the resident application returns to the processing at S401, and the resident application stands by for updating until the next update timing.

When it is necessary to update the FAQ information (S405: YES), the resident application transmits the information on the installed applications serving as the result of the processing at S402 to the FAQ server 20 (S406). Thereafter, the resident application acquires the latest FAQ information from the FAQ server 20 (S407). Then, the resident application updates the FAQ information 142 in the PC (S408). In accordance therewith, the FAQ information is periodically updated to be FAQ information corresponding to the applications installed in the PC 10. After the update, the resident application records the environmental information (i.e., the result of retrieval of the processing at S402) on the PC 10 under the present state (S409), which completes this processing.

As described above, in the installer 50 according to the first example, the FAQ information serving as documentary information on the peripheral device is associated with the programs, and FAQ information corresponding to an installed program is installed. Therefore, FAQ information suitable for the PC 10 is automatically acquired, and FAQ information corresponding to programs unrelated to the PC 10 is not installed. Accordingly, the installed FAQ information is only the information suitable for the PC 10 targeted for installation. Therefore, it is possible for a user to obtain correct information regardless of the environment of the PC 10 (a type, a version, a language, and the like of the installed application). Further, because there is no need for the user himself/herself to retrieve FAQ information, acquisition of incorrect FAQ information can be avoided. Further, with respect to the FAQ information to be installed, because only some of the information suitable for the PC 10 is installed, the FAQ information to be installed is of a minimal amount, which makes good use of the resources of the PC 10 serving as a destination for installation.

Further, in the PC 10 according to the second example, the FAQ information acquired from the FAQ server 20 is associated with the programs. Therefore, FAQ information corresponding to an installed program is acquired. Therefore, the FAQ information suitable for the environment of the PC 10 is automatically acquired, and FAQ information corresponding to programs unrelated to the PC 10 is not acquired. Accordingly, the updated FAQ information is information suitable for the PC 10. It is possible for a user to obtain correct information regardless of the environment of the PC 10. Further, because there is no need for the user himself/herself to retrieve FAQ information, acquisition of incorrect FAQ information can be avoided. Further, because the FAQ information on the deleted applications is deleted, old FAQ information can be avoided from being mixed therein.

While the invention has been shown and described with reference to certain exemplary embodiments thereof, it will be understood by those skilled in the art that various changes in form and details may be made therein without departing from the spirit and scope of the invention as defined by the appended claims.

For example, in the above-described exemplary embodiments, the FAQ information on the printer is updated. However, the device is not limited to the printer. The device may be any peripheral device to be controlled by an information device such as a PC. For example, the device may be a copier, a multifunctional device, a projector, or a scanner. Further, in the above-identified exemplary embodiments, the FAQ is browsed by utilizing the PC. However, the apparatus is not limited to a PC. The apparatus may be, for example, a workstation or a mobile telephone.

Further, in the embodiment, the printer is connected to the PC via the network. Alternatively, the PC and the printer may be directly connected via a printer interface.

What is claimed is:

1. A computer-readable medium having an installer stored thereon and readable by a peripheral device control apparatus that controls a peripheral device, the installer, when executed by the peripheral device control apparatus, causes the peripheral device control apparatus to install a program for the peripheral device control apparatus, the installer comprising:
a retrieval unit that retrieves an installed program installed on the peripheral device control apparatus to utilize the peripheral device;
an acquisition unit that acquires a documentary information on the peripheral device corresponding to the installed program retrieved by the retrieval unit; and
an installation unit that installs the documentary information acquired by the acquisition unit on the peripheral device control apparatus, on which the installed program is installed.

2. The computer-readable medium according to claim 1,
wherein the installer further comprises:
a retention unit that retains various types of documentary information on peripheral devices, and
wherein the acquisition unit extracts the documentary information on the peripheral device corresponding to the installed programs from the retention unit.

3. The computer-readable medium according to claim 1,
wherein the peripheral device control apparatus comprises a communication unit that is accessible to a server retaining various types of documentary information on peripheral devices, and
wherein, when the peripheral device control apparatus transmits data on the installed program to the server by the communication unit, the server extracts the installed program in accordance with the data transmitted by the peripheral device control apparatus, and the acquisition unit acquires the documentary information on the peripheral device corresponding to the installed program extracted by the server.

4. The computer-readable medium according to claim 1,
wherein the documentary information comprises at least one of a documentation, a help information and a FAQ information.

5. A peripheral device control apparatus comprising:
a program storage unit that stores a program to utilize a peripheral device;
a documentary information storage unit that stores a documentary information on the peripheral device;
an acceptance unit that accepts an update instruction of updating the documentary information stored in the documentary information storage unit;
a retrieval unit that retrieves an installed program installed on the program storage unit according to the update instruction accepted by the acceptance unit;
an acquisition unit that acquires the documentary information corresponding to installed programs retrieved by the retrieval unit; and
an update unit that updates the documentary information stored in the documentary information storage unit to the documentary information acquired by the acquisition unit.

6. The peripheral device control apparatus according to claim 5, further comprising:
a retention unit that retains various types of documentary information on peripheral devices,
wherein the acquisition unit acquires the documentary information on the peripheral device corresponding to the installed programs from the retention unit.

7. The peripheral device control apparatus according to claim 5, further comprising:
a communication unit that is accessible to a server retaining documentary information on the peripheral device corresponding to various types of programs,
wherein, when the peripheral device control apparatus transmits data on the installed program to the server by the communication unit, the server extracts the installed program in accordance with the data transmitted by the peripheral device control apparatus, and the acquisition unit acquires the documentary information on the peripheral device corresponding to the installed programs extracted by the server.

8. The peripheral device control apparatus according to claim 5, further comprising:
an instruction unit that outputs an instruction for update to the acceptance unit at predetermined intervals.

9. The peripheral device control apparatus according to claim 5,
wherein the documentary information comprises at least one of a documentation, a help information and a FAQ information.

10. A documentary information server comprising:
a database that retains various types of documentary information on peripheral devices;
a data acquisition unit that acquires a data on an installed program installed on a peripheral device control apparatus to utilize the peripheral device;
an extraction unit that extracts a documentary information on the peripheral device corresponding to the installed programs from the database on the basis of the data acquired by the data acquisition unit; and
a transmission unit that transmits the documentary information extracted by the extraction unit to the peripheral device control apparatus.

11. The documentary information server according to claim 10,
wherein the documentary information comprises at least one of a documentation, a help information and a FAQ information.

12. A method for installing a documentary information on a peripheral device control apparatus, the peripheral device control apparatus being coupled to a peripheral device and controlling the peripheral device, the method comprising:
detecting an installed program installed on the peripheral device control apparatus; and
installing a documentary information on the detected installed program on the peripheral device control apparatus.

13. The method for installing a documentary information according to claim 12, further comprising:
extracting only a documentary information on operation of the peripheral device coupled to the peripheral device controlling apparatus from a documentary information database retaining various types of documentary information on peripheral devices.

14. The method for installing a documentary information according to claim 12, further comprising:
acquiring a documentary information on the detected installed program;
wherein the acquiring a documentary information comprises:
connecting a server including a documentary information database;
sending an information on the detected installed program to the documentary information database; and
receiving the documentary information on the detected installed program from the documentary information database.

15. The method for installing a documentary information according to claim 12, further comprising:
acquiring a documentary information on the detected installed program,
wherein the acquiring a documentary information comprises reading the documentary information on the detected installed program from a computer-readable medium storing the documentary information database.

16. The method for installing a documentary information according to claim 12,
wherein the documentary information comprises at least one of a documentation, a help information and a FAQ information.
